(19) United States
(12) Patent Application Publication
(10) Pub. No.: US 2007/0208946 A1
(43) Pub. Date: Sep. 6, 2007

(54) High performance secure caching in the mid-tier

(75) Inventors: Thomas Baby, Foster City, CA (US); Asha Tarachandani, Newark, CA (US); Naveen Zalpuri, Foster City, CA (US); Sam Idicula, San Jose, CA (US); Nipun Agarwal, Santa Clara, CA (US); Gary Shu Ling, Belmont, CA (US); Ravi Murthy, Fremont, CA (US); Fredric Scott Goell, Foster City, CA (US); Eric Sedlar, San Francisco, CA (US)

Correspondence Address: HICKMAN PALERMO TRUONG & BECKER/ORACLE, 2055 GATEWAY PLACE, SUITE 550, SAN JOSE, CA, 95110-1089, US

(73) Assignee: ORACLE INTERNATIONAL CORPORATION, REDWOOD SHORES, CA (US)

(21) Appl. No.: 11/359,236

(22) Filed: Feb. 21, 2006

(51) Int. Cl. H04L 9/00

(52) U.S. Cl. 713/182

(57) ABSTRACT

In a multi-tier data server system, data from the first tier is cached in a mid-tier cache of the middle tier. Access control information from the first tier for the data is also cached within the mid-tier cache. Caching the security information in the middle tier allows the middle tier to make access control decisions regarding requests for data made by clients in the outer tier.

### FIELD OF THE INVENTION

The present invention relates to multi-tiered computer systems, and in particular, to access control of data accessed via the multi-tiered computer system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In a multi-tiered data server system with three or more tiers, a server in the first tier supplies data to clients in the outer tier. Data is cached in one or more servers in the mid-tier that sit between the first tier and the outer tier. The caches in the middle tier allow quicker access to data requested by the clients.

The mid-tier, however, does not evaluate the access control rights to data being requested by the clients.

To provide access control, several measures can be used. First, data requiring secured access is not cached in the mid-tier. Second, the mid-tier relies on the first tier to evaluate whether any particular user requesting access to data may access that data. In general, this requires one or more remote procedure invocations by the mid-tier to the first tier to verify whether any data requested by a client may be accessed in the way requested. In either case, the utility of the mid-tier cache is reduced, resulting in lower performance in first-to-outer-tier retrieval time.

### DESCRIPTION OF THE DRAWINGS

The present invention is illustrated by way of example, and not by way of limitation, in the figures of the accompanying drawings and in which like reference numerals refer to similar elements and in which:

FIG. 1 depicts a multi-tier data server system according to an embodiment of the present invention.

FIG. 2 depicts a computer system that may be used to implement an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details.

Described herein are techniques that allow access control to be performed more efficiently within a multi-tiered data server system. Access control information that resides within the first tier is exposed to the middle-tier, where the information is cached in a mid-tier cache. Access control information includes data that needs to be evaluated to determine access privileges for certain data of a user or other entity. Caching the access control information not only allows the middle tier to make access control decisions, but also to make such a decision based on cached information that is more efficiently and readily accessed. Messaging between the first tier and middle tier for the purposes of access control is reduced. The caching of such access control information is referred to herein as secure caching.

### Illustrative Embodiment

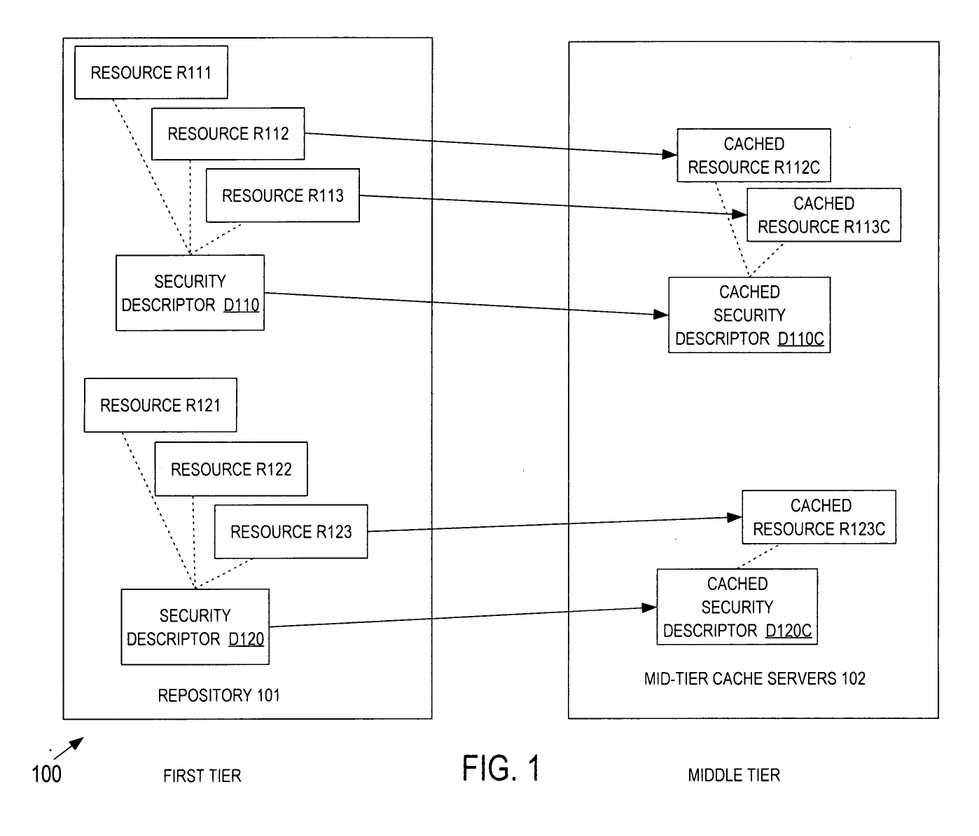

FIG. 1 depicts a multi-tiered system 101 used to illustrate secure caching according to an embodiment of the present invention. In the first tier of multi-tiered system 101 is a repository 101. A repository is a server that stores and/or manages access to “resources”. Although one repository is depicted in first tier multi-tiered system 101, the first tier may include multiple repositories.

A server is a combination of integrated software components and an allocation of computational resources, such as memory, disk storage, a computer, and processes on the node for executing the integrated software components on a processor, the combination of the software and computational resources being dedicated to one or more functions. A repository is a server dedicated to managing storage of and access to resources.

A resource is a data source. The term resource encompasses a broad range of kinds of data sources. A resource can not only be a file, but also a XML document, including one stored in a file or stored in the tables of a relational database system. A resource may also be a CGI script, that, when executed, dynamically generates data.

According to an embodiment, a repository is implemented within a database server that stores resources in a relational/object-relationally structured database. The resources are organized according to a hierarchy, which is represented by data structures within the database. Resources may be accessed and referenced by referring to their location within the resource hierarchy (e.g. by path name).

The middle tier of multi-tiered system 101 includes mid-tier cache servers 102. Mid-tier cache servers 102 service requests, from clients in the outer tier, for resources stored in the first tier of multi-tiered system 101. The middle tier may contain one or multiple servers. A resource from the first tier is provided to a client requesting the resource by transmitting the resource to the middle tier, which then stores a copy of the resource in a cache of mid-tier cache servers 102. For example, the resource is copied to the middle tier and stored therein in a cache when requested by a client in the outer tier and a valid copy of the resource is not already in a cache in the middle tier. When subsequently, a client in the outer tier requests a resource that is in the cache of the middle tier, the copy of the resource is furnished to the client by the middle tier.

According to an embodiment of the present invention, a mid-tier cache server 102 may be a proxy server of a firewall. The first tier sits behind the firewall and the outer tier sits outside the firewall. A client in the outer tier retrieves a resource from behind the firewall by requesting the resource from a proxy server, which, if the resource is not in the cache of the proxy server, retrieves the resource from the first tier and stores it in its cache. The proxy server furnishes the cache version of the resource to the client.

The proxy server communicates with the repository and the clients over a network using the HTTP protocol. The proxy server is interconnected with the first tier via a private network (e.g. enterprise intranet) and interconnected with the outer tier via a public network, such as the Internet. An embodiment of the present invention is not limited to any particular communication protocol or network configuration.

A cache is a storage medium used to temporarily store a version of a data item for more efficient access, where that data item may be obtained less efficiently from another source. The other, less-efficiently-accessed source is herein referred to as a secondary data source. A cache in the middle tier may be a volatile or non-volatile storage medium. Repository 101 is a secondary data source within multi-tiered system 101. The cache version is not stored persistently, and is removed or replaced in cache according to a cache management policy. One or more caches of mid-tier cache servers 102 can be referred to herein as a mid-tier cache.

A mid-tier cache may comprise several distinct caches. One type, a resource cache, is used to store resources. Another type, a security cache, is used to store access control information.

Security Descriptors

Among the access control information exposed to the middle tier are security descriptors. A security descriptor is a body of data (or portion thereof) that defines, at least in part, access privileges of one or more entities (e.g. users) to a set of resources associated with the security descriptor.

Referring to FIG. 1, security descriptor D110 defines access privileges for resources R111, R112, and R113. Security descriptor D120 defines access privileges for resources R121, R122, and R123. When access privileges for a resource are described, at least in part, by a security descriptor, the resource may be referred to herein as being subject to the security descriptor or the security descriptor may be referred to herein as applying to the resource.

An example of a security descriptor is an Access Control List (ACL). An ACL is a list of Access Control Entries (ACEs). Each ACE defines the privileges granted or denied to a user or to a group of users. An ACL may be stored in the first tier as a file or as rows in an access control table within a database system.

Caching of Security Descriptors

In general, a security descriptor is added to the mid-tier cache in response to receiving a request from an outer client for a resource subject to the security descriptor. When the middle tier receives another request for a resource subject to the cached security descriptor, the cached security descriptor may be used to determine the access privileges of the client for the resource. Based at least in part on the determination, the middle tier provides the resource requested.

To illustrate, FIG. 1 shows cached versions of resources from repository 101. The mid-tier cache of mid-tier cache servers 102 stores security descriptor D110C and cached security descriptor D120C. Cached security descriptor D110C is a cached version of security descriptor D110, and defines access privileges for resources subject to security descriptor D110 that are cached within the mid-tier cache. These include cached resources R112C and R113C, which are cache versions of resources R112 and R113, respectively.

Cached security descriptor D120C is a cached version of security descriptor D120, and defines access privileges for resources subject to security descriptor D110 and their cached versions within the mid-tier cache. These include cached resource R123C, which is a cache version of resource R123, respectively.

In response to mid-tier cache servers 102 receiving a request from a client for resource R112C, the security descriptor D110 is transmitted to mid-tier cache servers 102 and stored in mid-tier cache as security descriptor D110C. Cached security descriptor D110C is then examined to determine whether the request may be granted.

Subsequently, mid-tier cache servers 102 receive a request for a resource subject to security descriptor D110. The request may be for a resource cached in the mid-tier, or for one not yet cached there. In either case, if the cached security descriptor D110C resides in the mid-tier cache, which is the cached version of security descriptor D110, the cached security descriptor is evaluated to determine access privileges of the user making the request.

According to an embodiment, repository 101 limits which security descriptors may be exposed to the middle-tier, that is, which security descriptors can be cached. Data within the security descriptor itself may specify and dictate whether the security descriptor can be so exposed, or configuration data stored elsewhere within the first tier may control what security descriptors are so exposed. Repository 101 may also receive user input from a human administrator to configure how security descriptors are exposed to the middle tier.

Caching Auxiliary Security Information

Access control for a particular resource may require more access control information than is available in a security descriptor. Such access control information includes information used to authenticate users requesting a resource, and a list of owners of a particular cached resource. For example, a request to mid-tier cache servers 102 for a resource may be accompanied by authentication information for a user, such as a user name and password. In order to authenticate the user, mid-tier cache servers 102 need auxiliary information in the form of a valid password for the user name. In addition, the security descriptor for the requested resource specifies that the owners have one set of privileges while non-owners have a different set of privileges. In order to determine the access privileges of the user, and whether the type of access requested may be granted, mid-tier cache servers 102 requires access to auxiliary information such as the list of owners. The auxiliary information may be stored in the mid-tier cache.

To use a cached security descriptor, a mechanism is needed to track and identify which security descriptors apply to which resources. To this end, repository 101 stores descriptor-resource mappings. Descriptor-resource mappings define which resources are subject to which security descriptors, by, for example, mapping resources to security descriptors.

Descriptor-resource mappings may also be exposed to the middle-tier and stored within the mid-tier cache. When the middle tier receives a request for a resource, the middle tier uses descriptor-resource mappings in the mid-tier cache to identify which security descriptor applies to the resource and retrieves the security descriptor from mid-tier cache if it is stored there.

Registration

The caching of the security descriptors and auxiliary security information exposes security information to other servers. To ensure the security of such information is not exposed in a way that compromises the information, according to an embodiment, a mid-tier cache server in the middle tier must first successfully register itself before security descriptors and/or auxiliary security information are sent there and cached. Registration, as the term is used herein, refers to the procedure of authenticating a server as one that is authorized to receive access control information. Various authentication protocols may be used (e.g. username and password).

Once a server has successfully registered (i.e. authenticated itself), it may then participate in the secure caching of security descriptors and auxiliary information. Preferably, a secure out-of-band channel (one different than used to transmit resources) is established through which access control information is transmitted between the registered mid-tier cache server and the first tier.

Retaining Security Information In The Mid-tier Cache

Access control information may need to be removed from the mid-tier cache for a variety of reasons. For example, a cached security descriptor or descriptor-resource mapping in the mid-tier may have been changed within the first tier. Thus, any cached version of a security descriptor or descriptor-resource mapping may not be coherent with the version stored in repository 101. In this case, the cached security descriptor or descriptor-resource mapping may be removed from the mid-tier cache or marked as invalid so that it is no longer used to perform access control within the middle tier.

In addition, any cache management/replacement policy may be used to manage the mid-tier cache used to cache access control information. Such policies may be based on a variety of factors, including, without limitation, a maximum amount or portion of memory to use as the mid-tier cache for security descriptors, and a minimum or maximum period for retaining security descriptors.

Finally, a cached version of an item of access control information, including security descriptors, may not be an exact replica of the corresponding item in the first tier. While a valid cache version may not be an exact replica of its corresponding item in the first tier, the information reflected by the valid cache version should nevertheless be coherent or consistent with first tier item represented.

### Hardware Overview

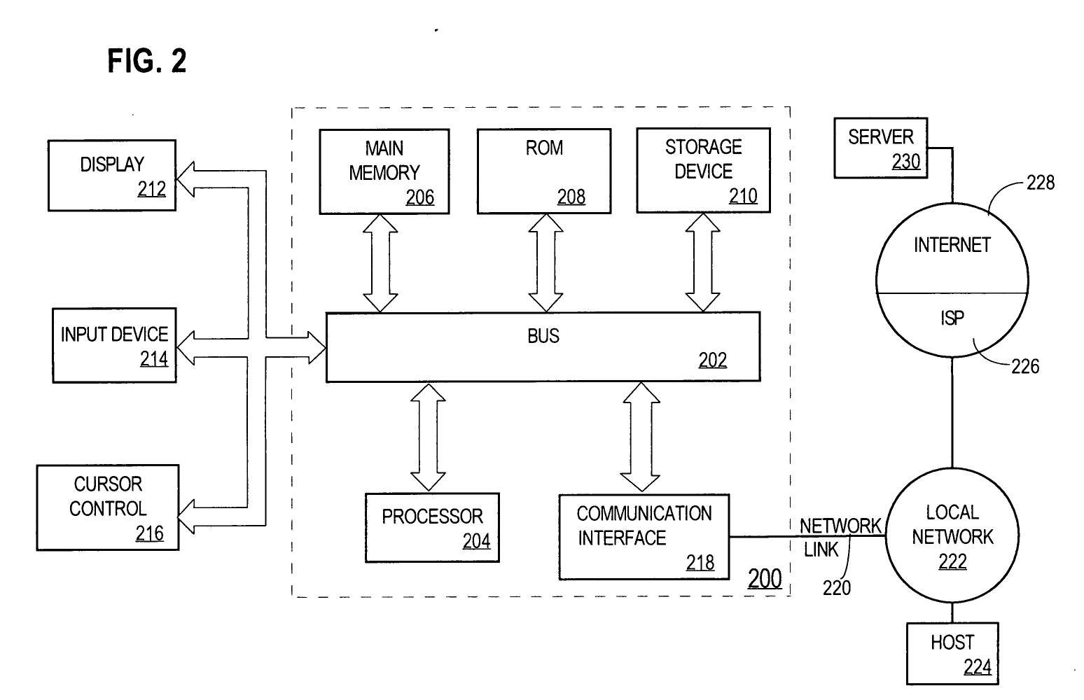

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising,
storing cache versions of security descriptors in a mid-tier cache of a middle tier of a multiple-tier data server system, said security descriptors being from a first tier of the multiple-tier data server system;
storing, in said mid-tier cache, cache versions of resources subject to said security descriptors;
wherein said cache versions of security descriptors include a certain cache version of a certain security descriptor of said security descriptors; and
said mid-tier determining whether a particular entity may be granted access to a certain resource of said resources based on said certain cache version of said certain security descriptor.

2. The method of claim 1, the steps further including storing in said mid-tier cache versions of user authentication information from said first tier.

3. The method of claim 2, using said user authentication information to authenticate a user associated with a request for said certain resource received by the middle tier from a client in an outer tier of said multiple-tier data server system.

4. The method of claim 1, the steps further including storing in said mid-tier cache cache versions of descriptor-resource mappings from said first tier, said descriptor-resource mappings describing which security descriptors apply to at least a portion of said resources.

5. The method of claim 4, the steps further including said middle tier determining which one or more security descriptors apply to said certain resource based on said cache versions of the descriptor-resource mappings.

6. The method of claim 1, wherein:
the cache versions of resources include a particular cache version of a particular resource in said first tier; and
the steps further include:
receiving a message from the first tier indicating that the particular cache version of the particular resource is no longer coherent with the particular resource, and
in response to receiving said message, handling said particular cache version as an invalid cache version.

7. The method of claim 1, wherein the steps further include:
storing in said mid-tier cache cache versions of descriptor-resource mappings from said first tier, said descriptor-resource mappings describing which security descriptors apply to at least a portion of said resources;
receiving a message from the first tier indicating that at least a portion of said cache versions of descriptor-resource mappings is no longer coherent with descriptor-resource mappings in said first tier; and
in response to receiving said message, handling said at least a portion of said cache versions as an invalid cache version.

8. A computer-implemented method, comprising:
a first tier storing resources accessible to clients in an outer tier of a multi-tier data server system that includes said first tier;
said first tier providing copies of said resources to a middle tier of said multi-tier data server system for storage in a middle tier cache of said middle tier;
said first tier storing security descriptors that apply to said resources; and
said first tier providing versions of security descriptors that apply to said resources to said middle tier for storage in the middle tier cache.

9. The method of claim 8, the steps further including said first tier sending said middle tier a message indicating that at least a portion of said versions of security descriptors is no longer coherent with said security descriptors.

10. The method of claim 8, wherein the steps further include:
said first tier storing user authentication information from said first tier; and
said first tier providing said user authentication information to said middle tier for storage in said middle tier cache.

11. The method of claim 10, the steps further including said first tier sending said middle tier a message indicating that at least a portion of user authentication information stored in said middle tier is no longer coherent with user authentication information stored in said first tier.

12. A machine-readable medium carrying one or more sequences of instructions, wherein execution of the one or more sequences of instructions by one or more processors causes the one or more processors to perform the steps of:
storing cache versions of security descriptors in a mid-tier cache of a middle tier of a multiple-tier data server system, said security descriptors being from a first tier of the multiple-tier data server system;
storing, in said mid-tier cache, cache versions of resources subject to said security descriptors;
wherein said cache versions of security descriptors include a certain cache version of a certain security descriptor of said security descriptors; and
said mid-tier determining whether a particular entity may be granted access to a certain resource of said resources based on said certain cache version of said certain security descriptor.

13. A machine-readable medium carrying one or more sequences of instructions, wherein execution of the one or more sequences of instructions by one or more processors causes the one or more processors to perform the steps of:
storing cache versions, of security descriptors in a mid-tier cache of a middle tier of a multiple-tier data server system, said security descriptors being from a first tier of the multiple-tier data server system;
storing, in said mid-tier cache, cache versions of resources subject to said security descriptors;
wherein said cache versions of security descriptors include a certain cache version of a certain security descriptor of said security descriptors; and
said mid-tier determining whether a particular entity may be granted access to a certain resource of said resources based on said certain cache version of said certain security descriptor.

14. The machine-readable medium of claim 13, the steps further including storing in said mid-tier cache versions of user authentication information from said first tier.

15. The machine-readable medium of claim 14, using said user authentication information to authenticate a user associated with a request for said certain resource received by the middle tier from a client in an outer tier of said multiple-tier data server system.

16. The machine-readable medium of claim 13, the steps further including storing in said mid-tier cache cache versions of descriptor-resource mappings from said first tier, said descriptor-resource mappings describing which security descriptors apply to at least a portion of said resources.

17. The machine-readable medium of claim 16, the steps further including said middle tier determining which one or more security descriptors apply to said certain resource based on said cache versions of the descriptor-resource mappings.

18. The machine-readable medium of claim 13, wherein:
the cache versions of resources include a particular cache version of a particular resource in said first tier; and
the steps further include:
receiving a message from the first tier indicating that the particular cache version of the particular resource is no longer coherent with the particular resource, and
in response to receiving said message, handling said particular cache version as an invalid cache version.

19. The machine-readable medium of claim 13, wherein the steps further include:
storing in said mid-tier cache cache versions of descriptor-resource mappings from said first tier, said descriptor-resource mappings describing which security descriptors apply to at least a portion of said resources;
receiving a message from the first tier indicating that at least a portion of said cache versions of descriptor-resource mappings is no longer coherent with descriptor-resource mappings in said first tier; and
in response to receiving said message, handling said at least a portion of said cache versions as an invalid cache version.

20. A machine-readable medium carrying one or more sequences of instructions, wherein execution of the one or more sequences of instructions by one or more processors causes the one or more processors to perform the steps of:
a first tier storing resources accessible to clients in an outer tier of a multi-tier data server system that includes said first tier;
said first tier providing copies of said resources to a middle tier of said multi-tier data server system for storage in a middle tier cache of said middle tier;
said first tier storing security descriptors that apply to said resources; and
said first tier providing versions of security descriptors that apply to said resources to said middle tier for storage in the middle tier cache.

21. The machine-readable medium of claim 20, the steps further including said first tier sending said middle tier a message indicating that at least a portion of said versions of security descriptors is no longer coherent with said security descriptors.

22. The machine-readable medium of claim 20, wherein the steps further include:
said first tier storing user authentication information from said first tier; and
said first tier providing said user authentication information to said middle tier for storage in said middle tier cache.

23. The machine-readable medium of claim 22, wherein the steps further include said first tier sending said middle tier a message indicating that at least a portion of user authentication information stored in said middle tier is no longer coherent with user authentication information stored in said first tier.
